(19) United States
(12) Patent Application Publication
(10) Pub. No.: US 2009/0085741 A1
(43) Pub. Date: Apr. 2, 2009

(54) METHODS AND APPARATUS FOR LOCATING AN RFID READER USING RFID TAGS

(75) Inventors: Ranjith RAVI, San Jose, CA (US); Saurabh BHARGAVA, San Jose, CA (US); Shilpa MOGHE, San Jose, CA (US); Ajay MALIK, Santa Clara, CA (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 11/863,044

(22) Filed: Sep. 27, 2007

(51) Int. Cl. G08B 13/14

(52) U.S. Cl. 340/572.1

(57) ABSTRACT

Methods and systems are provided for determining the location of an RFID reader within an environment having a plurality of RFID tags located therein. One method includes activating a tag via an RFID reader and receiving data from an RFID tag. The method also includes transmitting the data from the reader to an access port and determining the location of the reader based on the data. A system includes an RFID tag configured to transmit data when activated by an RFID reader. Furthermore, the system includes an access port configured to receive the data from the reader and a module configured to receive the data and determine the location of the reader based on the data. One RFID reader includes means for activating an RFID tag including data identifying a location of the tag, means for receiving the data, and means for transmitting the data to an access port.

### TECHNICAL FIELD

The present invention relates generally to radio frequency identification (RFID) systems, wireless local area networks (WLANs), and other such networks incorporating RF tags, and, more particularly, to methods of determining the location of an RFID reader within a building or other site.

### BACKGROUND

In recent years, Radio frequency identification (RFID) systems have achieved wide popularity in a number of applications, as they provide a cost-effective way to track the location of a large number of assets in real time. In large-scale application such as warehouses, retail spaces, and the like, many types of tags may exist in the environment (or “site”). Likewise, multiple types of readers, such as RFID readers, active tag readers, 802.11 tag readers, Zigbee tag readers, etc., are typically distributed throughout the space in the form of entryway readers, conveyer-belt readers, mobile readers, etc., and may be linked by network controller switches and the like. While it is common for RFID tags to be distributed throughout a commercial space to track assets, the tags have not been deployed in a way that would assist in tracking an RFID reader within the environment.

Accordingly, it is desirable to provide improved methods and systems for determining the location of an RFID reader in environments where multiple tags have been deployed. Furthermore, other desirable features and characteristics of the present invention will become apparent from the subsequent detailed description and the appended claims, taken in conjunction with the accompanying drawings and the foregoing technical field and background.

### BRIEF SUMMARY

The present invention provides systems and methods for determining the location of an RFID reader within a site having a plurality of RFID tags located therein. One embodiment of the method includes activating a first RFID tag via the RFID reader and receiving, via the RFID reader, first data from the first RFID tag. The method further includes transmitting the first data from the RFID reader to a first wireless access port and determining the location of the RFID reader based on the first data.

A system in accordance with one embodiment includes a first RFID tag located within the site, wherein the first RFID tag is configured to transmit first data when activated by the RFID reader. The system further includes a first access port configured to receive the first data from the RFID reader and a module in communication with the first access port, wherein the module is configured to determine the location of the RFID reader based on the first data.

An RFID reader according to various embodiments comprises means for activating a first RFID tag, wherein the first RFID tag includes first data identifying a location of the first RFID tag. The RFID reader further comprises means for receiving the first data from the first RFID tag and means for transmitting the first data to a first access port.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a system for locating an RFID reader in accordance with an exemplary embodiment of the present invention.

### DETAILED DESCRIPTION

The following detailed description is merely exemplary in nature and is not intended to limit the range of possible embodiments and applications. Furthermore, there is no intention to be bound by any theory presented in the preceding background or the following detailed description.

For simplicity and clarity of illustration, the drawing figures depict the general structure and/or manner of construction of the various embodiments. Descriptions and details of well-known features and techniques may be omitted to avoid unnecessarily obscuring other features. Elements in the drawings figures are not necessarily drawn to scale: the dimensions of some features may be exaggerated relative to other elements to assist improve understanding of the example embodiments.

Terms of enumeration such as “first,” “second,” “third,” and the like may be used for distinguishing between similar elements and not necessarily for describing a particular spatial or chronological order. These terms, so used, are interchangeable under appropriate circumstances. The embodiments of the invention described herein are, for example, capable of use in sequences other than those illustrated or otherwise described herein. Unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

The terms “comprise,” “include,” “have” and any variations thereof are used synonymously to denote non-exclusive inclusion. The terms “left,” right,” “in,” “out,” “front,” “back,” “up,” “down,” and other such directional terms are used to describe relative positions, not necessarily absolute positions in space. The term “exemplary” is used in the sense of “example,” rather than “ideal.”

For the sake of brevity, conventional techniques related to signal processing, data transmission, signaling, network control, the 802.11 family of specifications, wireless networks, RFID systems and specifications, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

The present invention generally relates to systems and methods for locating an RFID reader. Specifically, the systems and methods locate an RFID reader in a building or other site where RFID tags have previously been deployed.

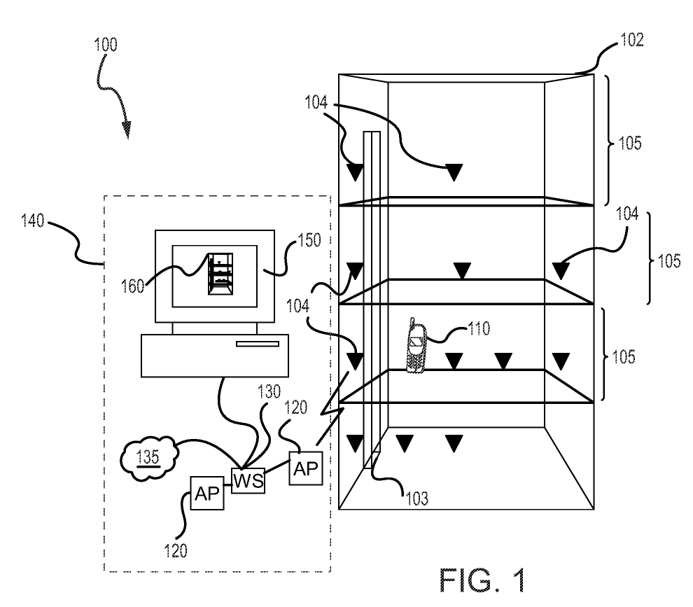

Referring now to FIG. 1, an example environment 102 useful in describing the present invention generally includes a building or other site (alternatively referred to as an “environment”). Note that while a three-dimensional, multi-floored building is illustrated in FIG. 1, the invention is not so limited. That is, environment 102 may be any two-dimensional or three-dimensional space within or without a building and other structure. Example environments include, for example, single-story buildings, multi-story buildings, school campuses, commercial buildings, warehouses, and the like structures.

A number of RF tags (“RFID tags,” or simply “tags”) 104 are distributed throughout environment 102. In general, these tags 104 are preferably pre-deployed throughout environment 102 either during or after construction.

In general, as described in further detail below, a system 100 includes an RFID reader 110 that suitably activates any nearby tags 104 and sends the relevant tag data to one or more access ports (APs) 120 and wireless switches 130 located remotely from RFID reader 110. Various software and hardware (e.g., computer 150, etc.) produce a display 160 indicative of the position of RFID reader 110 within environment 102.

Tags 104 may be positioned throughout environment 102 with a density and number that is appropriate given the power of the tags as well as structural details (e.g., internal architecture) of environment 102. That is, tags 104 may be distributed evenly throughout the site, or may be clustered in predefined “zones.” In the illustrated embodiment, for example, zones 105 are defined for each floor 105, as well as for an elevator bank 103. As shown, multiple tags 104 are included in each zone. In general, each zone preferably has at least one such tag 104, but may have any number, depending upon the size of the zone and other such factors.

Tags 104 may be one or more of various types of tags. Examples of tags 104 include, but are not limited to, active tags, passive tags, semi-active tags, WiFi tags, 801.11 tags, and the like RFID tags. Note that the term “RFID” is not meant to limit the invention to any particular type of tag. That is, the term “tag” refers, in general, to any RF element that can be communicated with and has an ID (or “ID signal”) that can be read by another component. In general, RFID tags (sometimes referred to as “transponders”) may be classified as either an active tag, a passive tag, or a semi-active tag. Active tags are devices that incorporate some form of power source (e.g., batteries, capacitors, or the like) and are typically always “on,” while passive tags are tags that are exclusively energized via an RF energy source received from a nearby antenna. Semi-active tags are tags with their own power source, but which are in a standby or inactive mode until they receive a signal from an external RFID reader, whereupon they “wake up” and operate for a time just as though they were active tags. While active tags are more powerful, and exhibit a greater range than passive tags, they also have a shorter lifetime and are significantly more expensive. Such tags are well known in the art, and need not be described in detail herein.

Furthermore, each tag 104 includes data (e.g., a tag ID, coordinates, etc.) that can be read by RFID reader 110, which data is also stored in a base station 140 (e.g., control center, etc.) and is used to assist in locating RFID reader 110. During operation, each tag 104 is read by RFID reader 110 when RFID reader 110 is within a range (e.g., about 0 meters to about 10 meters), which range varies depending on the RFID reader and RFID tag technology used. The data transmitted from each tag 104 is read by RFID reader 110 and transmitted to an RF switch (discussed below). The data transmitted from tag 104, via RFID reader 110, can then be used to determine the approximate location of RFID reader 110.

RFID reader 110 may have multiple associated antennas, and may incorporate additional functionality, such as filtering, cyclic-redundancy checks (CRC), and tag writing, as is known in the art. Each antenna within RFID reader 110 has an associated RF range (or “read point”), which depends upon, among other things, the strength of the respective antenna. The read point corresponds to the area around the antenna in which a tag 104 may be read by that antenna, and may be defined by a variety of shapes, depending upon the nature of the antenna. It is not uncommon for RF ranges or read points to overlap in real-world applications (e.g., doorways, small rooms, etc.).

Switching device 130 (alternatively referred to as an “RF switch,” “WS,” or simply “switch”) may be coupled to a network 135 (e.g., a WiFi network coupled to one or more other networks or devices) and communicate with one or more software applications (not shown). Wireless access ports 120 (alternatively referred to as “access ports” or “APs”) are configured to wirelessly communicate with RFID reader 110. Access ports 120 suitably communicate with switch 130 via appropriate communication lines (e.g., conventional Ethernet lines, or the like). Any number of additional and/or intervening switches, routers, servers and other network components may also be present in system 100.

A particular AP 120 may communicate with multiple RFID readers 110 (e.g., when multiple RFID readers 110 are located within environment 102). One or more APs 120 may be coupled to a single switching device 130, as illustrated, and may be distributed in any advantageous manner to a central office (not shown) located internal to or external to environment 102.

In general, RF Switch 130 determines the destination of the packets it receives and routes those packets to the appropriate AP 120. Thus, each AP 120 acts primarily as a conduit, sending/receiving RF transmissions via RF switches 130, and sending/receiving packets via a network protocol with WS 130.

Switch 130 may support any number of tags that use wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. As described in further detail below, switch 130 includes hardware, software, and/or firmware capable of carrying out the functions described herein. Thus, switch 130 may comprise one or more processors accompanied by storage units, displays, input/output devices, an operating system, database management software, networking software, and the like. Such systems are well known in the art, and need not be described in detail. Switch 130 may be configured as a general purpose computer, a network switch, or any other such network host. In a preferred embodiment, switch 130 is modeled on a network switch architecture but includes RF network controller software (or “module”) whose capabilities include, among other things, the ability to allow it to configure and monitor RFID reader 110 and its antenna(s).

Locationing of RFID reader 110 generally involves examining all of the data received from one or more RFID tags 104 at a particular time, and then using rules and a locationing algorithm to determine the most likely location of the RFID reader 110 based on the received tag data. As discussed above, the data for each RFID tag 104 is stored in base station 140 and system 100 is configured to reconcile the location of RFID reader 110 based on the tag data. Specifically, system 100 is configured to reconcile the location of an RFID reader 110 on a pre-defined floor map (i.e., a map of the location of RFID tags 104) and/or a zone map, and may also be configured produce a graphical representation identifying the position of RFID reader 110 within environment 102. Any such map and/or zone information may be preloaded, downloaded over network 135, or received from environment 102. Stated another way, the ID for each tag 104, and their respective locations, are preferably known prior to beginning the locationing process; however, this knowledge may be distributed over a number of systems and networks. In a particular embodiment, the placement of each RFID tag 104 is predefined, and nomenclature related to that placement is embedded within each RFID tag 104 (and saved in base station 140) so that a quick understanding of the location of the RFID tag 104 in relation to the floor and/or zone can be determined without the use of drawings.

The following example may be useful in understanding the operation of system 100, wherein RFID reader 110 is a WiFi-enabled laptop computer, a cellular telephone, a PDA, a Palm®, or other similar device. Here, as RFID reader 110 is transported (e.g., by a conveyor belt, a person, a motor vehicle, etc.) through environment 102, RFID reader 110 reads data from each RFID tag 104 that RFID reader 110 comes within range of. RFID reader 110 then transmits the tag data (via RF switch 130 and AP 120) to computer 150 and is represented on display 160. That is, the location of RFID reader 110 may be known in real-time as RFID reader 110 is transported through environment 102.

In another example where environment 102 is a warehouse, RFID reader 110 may be integrated within a forklift to determine and track the location of the forklift as it navigates through the warehouse. That is, as computer 160 receives the location data that RFID reader 110 has read from one or more of tags 104, the path(s) that the forklift traveled over a given period of time may be determined and saved by computer 150.

It should be appreciated that the example embodiment or embodiments described herein are not intended to limit the scope, applicability, or configuration of the invention in any way. For example, these methods may be used in connection with standard barcode readers and the like. In general, the foregoing detailed description and examples will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for determining the location of an RFID reader within a site having a plurality of RFID tags located therein, the method comprising:
activating a first RFID tag via the RFID reader;
receiving, via the RFID reader, first data from the first RFID tag;
transmitting the first data from the RFID reader to a first access port; and
determining the location of the RFID reader based on the first data.

2. The method of claim 1, wherein activating the first RFID tag comprises activating one of an active RFID tag and a passive RFID tag.

3. The method of claim 1, wherein receiving data acquired from the first RFID tag comprises receiving predetermined location information associated with the first RFID tag.

4. The method of claim 1, further comprising providing a graphical representation of the location of the RFID reader on a display.

5. The method of claim 1, further comprising transmitting the first data to a wireless switch in communication with the first access port.

6. The method of claim 5, further comprising transmitting the first data to a central office in communication with the wireless switch.

7. The method of claim 1, wherein determining the location comprises determining the location utilizing a module in communication with the first access port.

8. The method of claim 1, further comprising:
activating a second RFID tag via the RFID reader;
receiving, via the RFID reader, second data from the second RFID tag;
transmitting the second data from the RFID reader to a second access port; and
determining the location of the RFID reader based on the second data.

9. The method of claim 8, wherein determining the location comprises determining the location utilizing a module in communication with the first access port and the second access port.

10. The method of claim 8, further comprising:
transmitting the first data and the second data to a wireless switch in communication with the first access port and the second access port; and
transmitting the first data and the second data to a central office in communication with the wireless switch.

11. A system for determining the location of an RFID reader within a site, comprising:
a first RFID tag located within the site, the first RFID tag configured to transmit first data when activated by the RFID reader;
a first access port configured to receive the first data from the RFID reader; and
a module in communication with the first access port, the module configured to determine the location of the RFID reader based on the first data.

12. The system of claim 11, wherein the first RFID tag is configured to receive power from the RFID reader.

13. The system of claim 11, wherein the first data comprises predetermined location information associated with the first RFID tag.

14. The system of claim 11, further comprising a display in communication with the module, the display configured to provide a graphical representation of the location of the RFID reader.

15. The system of claim 11, further comprising a wireless switch in communication with the first access port, the wireless switch configured to receive the first data from the first access port.

16. The system of claim 15, further comprising a central office in communication with the wireless switch, the central office configured to receive the first data from the first access port.

17. The system of claim 11, further comprising:
a second RFID tag located within the site, the second RFID tag configured to transmit second data when activated by the RFID reader; and
a second access port configured to receive the second data from the RFID reader, wherein the module is further configured to determine the location of the RFID reader based on the second data.

18. An RFID reader, comprising:
means for activating a first RFID tag, the first RFID tag including first data identifying a location of the first RFID tag;
means for receiving the first data from the first RFID tag; and
means for transmitting the first data to a first access port.

19. The RFID reader of claim 18, wherein the activating means comprises means for activating one of an active RFID tag and a passive RFID tag.

20. The RFID reader of claim 18, further comprising:
means for activating a second RFID tag, the second RFID tag including second data identifying a location of the second RFID tag;
means for receiving the second data from the second RFID tag; and
means for transmitting the second data to a second access port.
